(19) United States
(12) Patent Application Publication
(10) Pub. No.: US 2006/0267869 A1
(43) Pub. Date: Nov. 30, 2006

(54) Plasma display panel

(76) Inventor: Jae-Ik Kwon, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/433,538

(22) Filed: May 12, 2006

(30) Foreign Application Priority Data
May 26, 2005 (KR) 10-2005-0044458

(51) Int. Cl. G09G 3/28

(52) U.S. Cl. 345/60

(57) ABSTRACT

Provided is a plasma display panel having improved electrode-connecting units so as to achieve stable electrical connection between an electrode sheet and a substrate. Provided is also a plasma display panel which simplifies the manufacturing process by forming all of the electrode-connecting units on the same substrate, thereby reducing the manufacturing costs. The plasma display panel includes a pair of substrates spaced apart from each other and arranged substantially parallel to each other, an electrode sheet arranged between the two substrates, in which a barrier structure that define discharge cells where discharge occur and electrodes to which a voltage is applied are formed, sheet-side terminal units arranged outside the electrode sheet and electrically connected to the electrodes, substrate-side terminal units arranged outside one of the two substrates and electrically connected to the sheet-side terminal units, and electrode-connecting units interposed between the sheet-side terminal units and the substrate-side terminal units.

### CROSS-REFERENCE TO RELATED APPLICATIONS

This application claims the benefit of Korean Patent Application No. 10-2005-0044458, filed on May 26, 2005, in the Korean Intellectual Property Office, the disclosure of which is incorporated herein in its entirety by reference.

### BACKGROUND OF THE INVENTION

1. Field of the Invention

The present embodiments relate to a plasma display panel (PDP), and more particularly, to a PDP having improved electrode-connecting units so as to achieve stable electrical connection between an electrode sheet and a substrate.

2. Description of the Related Art

Plasma display panels (PDPs) are flat display panels which display an image by using the gas discharge phenomenon. PDPs are being recently spotlighted because they can be thinly shaped and have high-definition large screens having wide viewing angles.

PDPs include a first substrate and a second substrate facing each other at a certain distance, discharge cells where discharge is generated, and electrodes to which voltages are applied. A discharge is generated in the discharge cells by direct current (DC) or alternating current (AC) voltage applied between the electrodes. Ultraviolet rays emitted from a discharge gas excite a phosphor material to generate visible light, so that an image is displayed on PDPs.

In addition, the electrodes included in PDPs are made up of address electrodes causing address discharge and sustain electrodes maintaining discharge. These electrodes are electrically coupled to driving circuit units that generate electric signals to drive the PDPs via signal transmission means. Here, the sustain electrodes are made up of X electrodes being common electrodes and Y electrodes being scan electrodes causing the address discharge in cooperation with the address electrodes.

Moreover, these electrodes are electrically coupled to the signal transmission means sequentially via electrode terminal connection units and electrode terminal units.

FIG. 1 is a partial cutaway cross-section showing a connection between electrode terminal connection units 30a and 30b of a PDP that includes an electrode sheet 15.

As shown in FIG. 1, the electrode terminal connection units 30a and 30b may be formed on an end of a substrate 12 and an end of the electrode sheet 15, respectively. The electrode terminal connection units 30b formed on the electrode sheet 15 contact and are electrically connected to the electrode terminal connection units 30a formed on the substrate 12. The free ends of the electrode terminal connection units 30a formed on the substrate 12 are electrically connected to electrodes so that an external voltage is applied to the electrodes.

The substrate 12 and the electrode sheet 15 are individually manufactured and then assembled together. The substrate 12 may be deformed during a firing process included in its manufacturing process, that is, may be bent as shown in FIG. 1. When this deformation occurs, the electrode terminal connection units 30a and 30b may fail to contact each other or may unstably contact each other during the assembly of the electrode sheet 15 and the substrate 12.

### SUMMARY OF THE INVENTION

The present embodiments provide a plasma display panel having improved electrode-connecting units so as to achieve stable electrical connection between an electrode sheet and a substrate.

The present embodiments also provide a plasma display panel which simplifies the manufacturing process by forming all of the electrode-connecting units on the same substrate, thereby reducing the manufacturing costs.

According to an aspect of the present embodiments, there is provided a plasma display panel including a pair of substrates spaced apart from each other and arranged substantially parallel to each other, an electrode sheet arranged between the two substrates, comprising electrodes and a barrier structure that defines discharge cells where discharge occurs, sheet-side terminal units arranged outside the electrode sheet and electrically connected to the electrodes, substrate-side terminal units arranged outside one of the two substrates and electrically connected to the sheet-side terminal units, and electrode-connecting units interposed between the sheet-side terminal units and the substrate-side terminal units.

Each of the electrode-connecting units may have a predetermined length and a cross-section whose size is uniform along the length.

The electrode-connecting units may be formed on the substrate-side terminal units and connected to the sheet-side terminal units.

Each of the electrode-connecting units may be designed so that each of the substrate-side terminal units is smaller than a cross-section of the other end contacting each of the sheet-side terminal units.

A discharge gas may be included in the discharge cells and phosphor layers may be coated on the discharge cells.

The electrodes formed in the electrode sheet may include common electrodes and scan electrodes.

The common electrodes and the scan electrodes may cross each other.

The plasma display panel may include address electrodes arranged in the electrode sheet or one of the two substrates and intersecting the scan electrodes.

The address electrodes may be arranged between the common electrodes and the scan electrodes on the electrode sheet.

Each of the address electrodes may be in the shape of a chain including portions surrounding a line of discharge cells and portions connecting portions that surround adjacent discharge cells.

The address electrodes may be arranged to have a ladder shape which surrounds the discharge cells.

Each of the common electrodes and/or the scan electrodes may be in the shape of a chain including portions surrounding a line of discharge cells and portions connecting portions that surround adjacent discharge cells.

The common electrodes and/or the scan electrodes may be arranged to have a ladder shape which surrounds the discharge cells.

The sheet-side terminal units may include sheet-side common electrode terminal units connected to the common electrodes and sheet-side scan electrode terminal units connected to the scan electrodes. The substrate-side terminal units may include substrate-side common electrode terminal units and substrate-side scan electrode terminal units. The sheet-side common electrode terminal units may be electrically connected to the substrate-side common electrode terminal units, and the sheet-side scan electrode terminal unit may be electrically connected to the substrate-side scan electrode terminal units. At least one electrode-connecting unit may be interposed in at least one space between each common electrode terminal unit and each scan electrode terminal unit.

The electrode sheet may further include protective layers each covering at least a portion of each of the inner walls of the barrier structure.

Grooves corresponding to spaces defined by the barrier structure in the electrode sheet may be formed on at least one of the two substrates so that the volume of each of the discharge cells increases.

A phosphor layer may be formed in at least a portion of each of the grooves which define the discharge cells.

Substrate-side address electrode terminal units connected to the address electrodes may be arranged on at least one of the two substrates.

The electrode sheet may be formed using the thick film ceramic sheet (TFCS) method.

### BRIEF DESCRIPTION OF THE DRAWINGS

The above and other features and advantages of the present embodiments will become more apparent by describing in detail exemplary embodiments thereof with reference to the attached drawings in which:

FIG. 1 is a cross-section showing the electrode terminal connection part of the conventional plasma display panel;

FIG. 2 is a partially cutaway perspective view of a plasma display panel (PDP) according to an embodiment;

FIG. 3 is a cross-sectional view taken along line III-III of FIG. 2;

FIG. 4 is a perspective view of electrodes included in the PDP shown in FIGS. 2 and 3;

FIG. 5 is a partial cross-section showing electrode terminal connection units of the PDP shown in FIGS. 2 and 3; and

FIG. 6 is a partial section showing the electrode terminal connection units of FIG. 5 in a state of being not yet combined with electrode terminals.

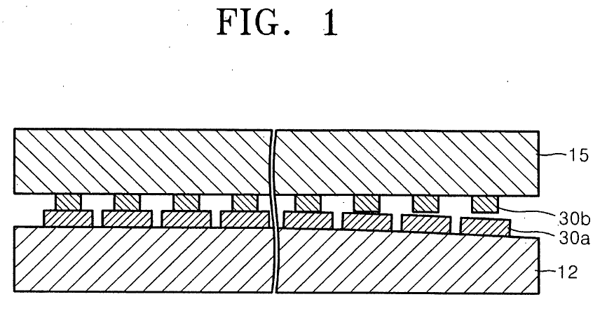

### DETAILED DESCRIPTION OF THE INVENTION

The present embodiments will now be described more fully with reference to the accompanying drawings, in which exemplary embodiments are shown.

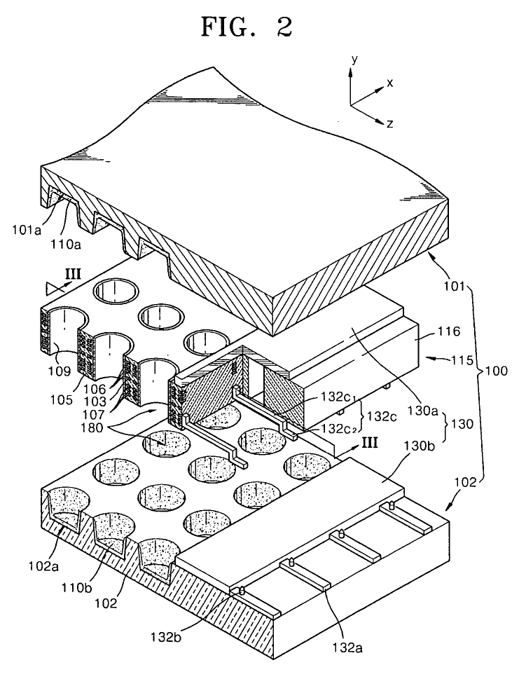

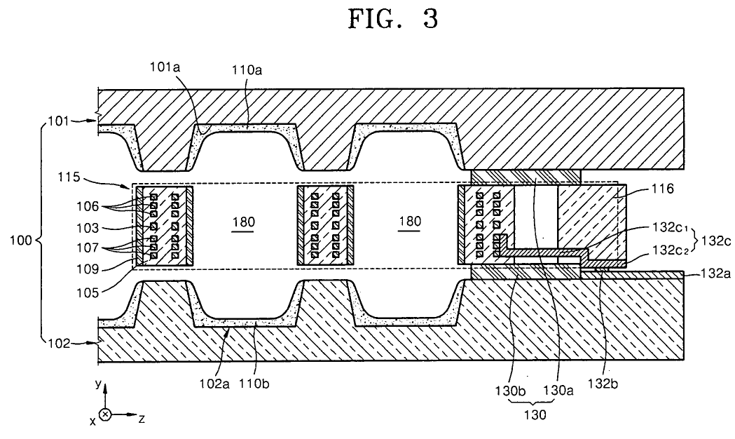

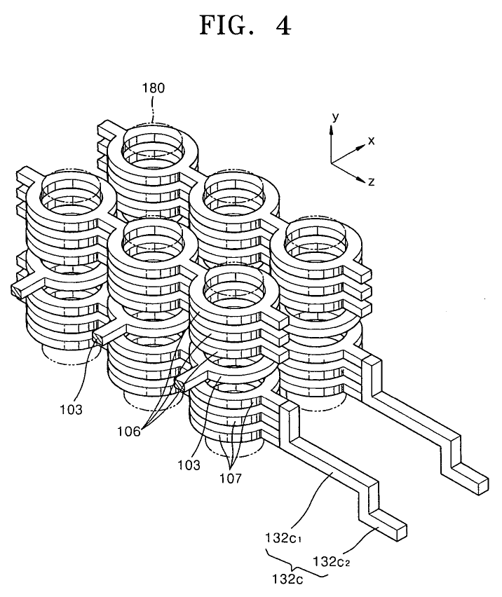

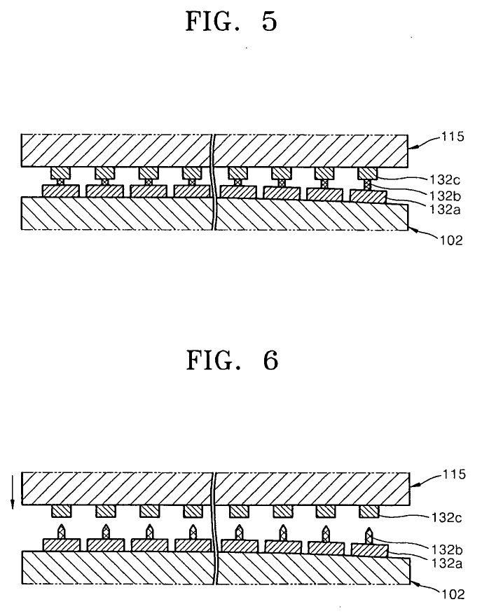

FIG. 2 illustrates a configuration of a PDP 100 according to an embodiment. FIG. 3 is a cross-sectional view taken along line III-III of FIG. 2. FIG. 4 is a perspective view of electrodes included in the PDP shown in FIGS. 2 and 3. FIG. 5 is a partial cross-section showing electrode terminal connection units of the PDP shown in FIGS. 2 and 3. FIG. 6 is a partial section showing the electrode terminal connection units of FIG. 5 in a state of being not yet combined with electrode terminals.

As illustrated in FIGS. 2 and 3, the PDP 100 includes a first substrate 101, a second substrate 102 spaced apart from the first substrate 101 and facing the first substrate 101, a barrier structure 105 disposed between the first and second substrates 101 and 102 and defining discharge cells 180 where discharge is generated, an electrode sheet 115 in which sustain electrodes 106 and 107 to which voltages are applied are formed, and a sealing material 130 sealing the electrode sheet 115 and the first substrate 101 together and the electrode 115 and the second substrate 102 together. Here, the sustain electrodes 106 are first sustain electrodes 106, and the sustain electrodes 107 are second sustain electrodes 107.

In the PDP 100, the first substrate 101 is arranged on one side of the electrode sheet 115, and the second substrate 102 is arranged on the other side thereof.

In this case, grooves 101a are formed in one surface of the first substrate 101 that faces the discharge cells 180, and second grooves 102a are formed in one surface of the second substrate 102 that faces the discharge cells 180. The first and second grooves 101a and 102a play the role of increasing the volumes of the discharge cells where discharge occurs. Although it is illustrated in FIG. 2 that the first and second grooves 101a and 102a have circular cross-sections, the cross-section of each groove according to the present embodiments are not restricted to the circular cross-section. Accordingly, the shape of each discharge cell according to the present embodiments is not restricted to a cylinder as shown in FIG. 2.

The first and second grooves 101a and 102a are each formed to have a predetermined depth. Due to the first grooves 101a positioned in front of the discharge cells, the thickness of the first substrate 101 is reduced. Accordingly, the transmittance of visible light emitted through the first substrate 101 to the outside is increased.

Moreover, red (R), green (G), and blue (B) phosphor layers 110a are coated on the first grooves 101a to have a predetermined thickness, and red, green, and blue phosphor layers 110b are coated on the second grooves 102a to have a predetermined thickness. However, the positions of the red, green, and blue phosphor layers 110a and 110b are not limited to the surfaces of the first and second grooves 101a and 102a but the R, G, and B phosphor layers 110a and 110b may be formed in the other various locations within the discharge cells 180.

The R, G, and B phosphor layers 110a and 110b cover at least portions of the inner sidewalls of the barrier structure 105 and are formed of photo-luminescence (PL) type phosphor which is excited by ultraviolet rays and generates visible rays. R phosphor used to form the R phosphor layers 10a and 10b may be (Y,Gd) BO₃Eu³⁺, etc. G phosphor used to form the G phosphor layers 110a and 110b may be Zn₂Si0₄:Mn²⁺, etc. B phosphor used to form the B phosphor layers 110a and 110b may be BaMgAl₁₀O₁₇:Eu²⁺, etc.

Although it is illustrated in FIG. 2 that the grooves 101a and 102a are formed on the first and second substrates 101 and 102, respectively, and the phosphor layers 110a and 110b are coated on the grooves 101a and 102a, respectively, the present embodiments are not limited to this illustration. The grooves 101a and 102a may be formed on one of the first and second substrates 101 and 102. The phosphor layers 110a and 110b may be coated on either the grooves 101a or the grooves 102a.

The electrode sheet 115 is preferably formed using the thick film ceramic sheet (TFCS) method. However, the present embodiments are not restricted to this method but the electrode sheet 115 may be formed using the other various methods. The TFCS method is a process in which an electrode grid layer, a dielectric layer, etc. are successively formed on a ceramic substrate by repeating a printing process and the resultant structure is punched to simultaneously obtain spaces in which discharge cells are formed. If necessary, processes, such as, a foaming process, a drying process, or a firing process, may be added to the TFCS method. If the electrode sheet 115 is formed using the TFCS method, the manufacturing process of a PDP becomes simpler than an existing process.

As shown in FIGS. 2 through 4, the first and second sustain electrodes 106 and 107 which are used to achieve sustain discharge are formed in the electrode sheet 115. At least one sheet-side terminal unit 132c electrically connected to each of the second sustain electrodes 107 is formed on the electrode sheet 115. Although only the sheet-side terminal units connected to the second sustain electrodes 107 are illustrated in FIGS. 2 through 4, sheet-side terminal units electrically connected to the first sustain electrode 106 may be further formed in the electrode sheet 115. The sheet-side terminal units electrically connected to the first sustain electrodes 106 may be installed on the upper side of FIG. 2, that is, close to the first substrate 10 or on the opposite side of the PDP which is not seen in FIGS. 2 and 3. In other words, the sheet-side terminal units connected to the first sustain electrodes 106 and the sheet-side terminal units 132c connected to the second sustain electrodes 107 may be arranged on the left and right sides, respectively, of the PDP 100 or arranged on one side of the left and right sides thereof.

The case where the sheet-side terminal units 132c connected to the second sustain electrodes 107 and sheet-side terminal units connected to the first sustain electrodes 106 are arranged on different sides of the PDP 100 will now be described.

As shown in FIG. 4, preferably, the sheet-side terminal units 132c extend from one end of the electrodes 107 in a direction in which the discharge cells 180 are arranged, that is, in direction z. In other words, the plurality of sheet-side terminal units 132c are substantially parallel to each other in the direction in which the discharge cells 180 are arranged. However, the sheet-side terminal units 132c may be arranged at other various locations and in other various shapes.

At least one substrate-side terminal unit 132a electrically connected to the second sustain electrodes 107 is formed on the second substrate 102. The substrate-side terminal units 132a are electrically connected to the sheet-side terminal units 132c.

The first and second sustain electrodes 106 and 107 and the sheet-side terminal units are formed simultaneously in the electrode sheet 115. The substrate-side terminal units are separately formed on the second substrate 102 and/or the first substrate 101. Then, the sheet-side terminal unit 132c and the substrate-side terminal units 132a (see FIG. 2) are arranged to be electrically connected to each other. The manufacture of the PDP 100 can be simplified by using the electrode sheet 115 having this configuration.

The junction of the sheet-side terminal units with the substrate-side terminal units is well illustrated in FIGS. 5 and 6.

As shown in FIG. 5, electrode-connecting units 132b each having a predetermined length are interposed between the sheet-side terminal units 132c and the substrate-side terminal units 132a. Even when one of the substrates 101 and 102, for example, the substrate 102, is bent during the firing process as shown in FIG. 5, the electrode-connecting units 132b can securely couple the sheet-side terminal units to the substrate-side terminal units.

As shown in FIG. 6, the electrode-connecting units 132b may have the shapes of protrusions with predetermined lengths formed on the upper surface of the substrate-side terminal units 132a. The protrusion may have various shapes, such as, a circular column, a probe, etc. However, it is preferable that the protrusion has the shape of a probe whose diameter decreases as going toward its end.

The ends of the electrode-connecting units 132b partially melt at a high temperature during firing of the sealing material and exhausting. The electrode-connecting units 132b can make the electrode terminal units 132a and 132c securely electrically connected to each other even when intervals between the electrode terminal units 132a and 132c are different.

That is, as shown in FIG. 5, where a substrate-side terminal unit 132a and a sheet-side terminal unit 132c are close to each other, a corresponding electrode-connecting unit 132b melts and thus its length is short. Where a sheet-side terminal unit 132c and a substrate-side terminal unit 132a are distant from each other, its corresponding electrode-connecting unit 132b slightly melts and thus its length is kept long. In this way, the sheet-side terminal units 132c and the substrate-side terminal units 132a are electrically connected to each other.

As shown in FIGS. 2 through 4, each of the sheet-side terminal units 132c may include a base portion 132c₁ and a terminal connection portion 132c₂. The terminal connection portion 132c₂ is arranged at an end of the base portion 132c₁ and contacts an electrode-connecting unit 132b formed on a substrate-side terminal unit 132a. In the case where the terminal connection unit 132c₂ is arranged to face the substrate-side terminal unit 132a as shown in FIGS. 2 through 4, the sheet-side terminal unit 132c can more steadily maintain the electrical connection with the substrate-side terminal unit 132a.

Referring to FIG. 2, a dummy unit 116 can be formed in the electrode sheet 115 which covers the sheet-side terminal units 132c. Preferably, the terminal connection portions 132c₂ of the sheet-side terminal units 132c are exposed on a surface of the dummy unit 116 that faces the substrate-side terminal units 132a.

That is, the dummy unit 116 of the electrode sheet 115 can prevent the sheet-side terminal units 132c from being damaged by external shocks or the like by covering the sheet-side terminal units 132c. Here, the dummy unit 116 is preferably formed of a dielectric material, but the present embodiments are not restricted to a dielectric material. Because the terminal connection portions 132c₂ are exposed from the dummy unit 116 and adhere closely to the substrate-side terminal units 132a, the electrical connections between the terminal units 132c and 132a are more securely achieved.

The sealing material 130 is arranged between the electrode sheet 115 and each of the substrates 101 and 102. In other words, sealing materials 130a and 130b are arranged between the electrode sheet 115 and the first substrate 101 and between the electrode sheet 115 and the second substrate 102, respectively. In one embodiment, the sealing material 130 is arranged along the edges of each of the substrates 101 and 102 so as to form a looped curve. Here, the looped curve denotes a curve on which one point starts in one direction and returns to the start point. The looped curve should be defined as an expanded concept including not only a curve but also a straight line or a combination of a straight line and a curve.

Accordingly, the sealing material 130 maintains airtightness between each of the substrates 101 and 102 and the electrode sheet 115, that is, a tight closure of the internal space of the PDP 100 and thus can prevent discharge gas from leaking out of the PDP 100.

Although it is illustrated in FIGS. 2 through 4 the substrate-side terminal units 132a are formed on the second substrate 102 and have strip shapes, the present embodiments are not restricted to this illustration. In other words, the substrate-side terminal units 132a may have various shapes as long as they conform to the shapes of the end portions of the sheet-side terminal units 132c, namely, the shapes of the terminal connection portions 132c₂. Of course, it is preferable that the substrate-side terminal units 132a are positioned at locations facing the end portions of the sheet-side terminal units 132c, namely, the terminal connection portions 132c₂ over the second substrate 102.

Although not illustrated in the drawings, the structure and operation of the sheet-side terminal units (not shown) and the substrate-side terminal units (not shown) for the second sustain electrodes 106 are almost identical to those for the first sustain electrodes 107. Therefore, a detailed description thereof will be omitted herein.

Discharge gas is included in the discharge cells 180. The discharge gas may be at least one of xenon (Xe), neon (Ne), helium (He), and argon (Ar) or a mixture of two or more of these gases.

In the PDP 100, the electrodes 103, 106, and 107 formed in the electrode sheet 15 are preferably designed to surround the discharge cells 180 within the barrier structure 105, and at least one first sustain electrode 106 and at least one second sustain electrode 107 which are spaced apart from each other are included in the barrier structure 105. The first sustain electrode 106 is a common electrode, and the second sustain electrode 107 is a scan electrode.

In one embodiment, each of the first sustain electrodes 106 extends while surrounding a line of discharge cells 180 arrayed in a direction, e.g., direction z. Each of the second sustain electrodes 107 extends while surrounding a line of discharge cells 180 arrayed in a direction, e.g., direction z.

Moreover, because the sustain electrodes 106 and 107 are arranged within the barrier structure 105, they do not disturb the passage of visible light emitted from the discharge cells 180. Therefore, the sustain electrodes 106 and 107 are not necessarily formed of transparent indium tin oxide (ITO) but may be formed of a cost-effective material having good electrical conductivity, such as, Ag, Cu, or Cr. In this way, non-uniform image display and a high manufacturing cost caused by the use of ITO electrodes can be prevented.

Although only the PDP 100 in which electrodes are included within a barrier structure is illustrated in the drawings, the present embodiments are not restricted to this embodiment. Instead, the present embodiments may be realized in the other various embodiments, such as a 3-electrode surface discharge type PDP.

Moreover, although it is illustrated in FIGS. 2, 3, and 4 that three microelectrodes constitute a first sustain electrode 106 and likewise for the second sustain electrodes 107, the present embodiments are not restricted to the number of microelectrodes. For example, two or more than four microelectrodes may constitute one sustain electrode 106 and likewise for the sustain electrodes 107.

In this way, difficulties in forming the sustain electrodes 106 and 107 thickly can be overcome. In other words, the effect of increasing the thickness of each of the sustain electrodes 106 and 107 can be sufficiently achieved by stacking a plurality of microelectrodes and connecting the microelectrodes to one another.

However, the present embodiments are not restricted to the use of a plurality of microelectrodes to constitute each sustain electrode. Each of the sustain electrodes 106 and 107 may be made up of a single electrode.

The first sustain electrodes 106 may extend in a first direction, and the second sustain electrodes 107 may extend in a second direction and cross the first sustain electrode 106. In this case, because discharge cells 180 where discharge is to occur can be selected by applying a voltage between the two electrodes 106 and 107, no address electrodes are needed.

Alternatively, the first sustain electrodes 106 and the second sustain electrodes 107 may extend substantially parallel to each other, and the address electrodes 103 intersecting the first and second sustain electrodes 106 and 107 may be further included in the electrode sheet 115. The address electrodes 103 preferably extend while surrounding the discharge cells 180.

As shown in FIGS. 2 through 4, the first sustain electrodes 106, the address electrodes 103, and the second sustain electrodes 107 may be sequentially stacked in the direction from the first substrate 101 to the second substrate 102. The address electrodes 103 cause address discharge which facilitates occurrence of sustain discharge between the second sustain electrodes 107 and the first sustain electrodes 106. More specifically, the address electrodes 103 reduce a voltage which fires sustain discharge.

The address voltage decreases as the distance between the address electrodes and the scan electrodes becomes shorter. In the present embodiment, address discharge is generated between the second sustain electrodes 107 and the address electrodes 103. However, the present embodiments are not restricted to the generation of address discharge between the second sustain electrodes 107 and the address electrodes 103. Although not illustrated in the drawings, the first sustain electrodes 106, the second sustain electrodes 107, and the address electrodes 103 may be sequentially stacked in the direction from the first substrate 101 to the second substrate 102. In this case, the second sustain electrodes 107, serving as scan electrodes, are nearer to the address electrodes 103 than the first sustain electrodes 106 are.

The first sustain electrodes 106, the second sustain electrodes 107, and the address electrodes 103 do not reduce the transmittance of visible light because they are built in the barrier structure 105. Therefore, the first and second sustain electrodes 106 and 107 and the address electrodes 103 may be formed of conductive metal, such as aluminum or copper, instead of being transparent electrodes. Accordingly, a voltage drop in the electrodes is small, and thus stable signal transmission is possible.

Although not shown in the drawings, it is preferable that sheet-side address electrode terminal units electrically connected to the address electrodes 103 for address discharge are formed in the electrode sheet 115. That is, the manufacturing process of a PDP can be simplified by forming the address electrodes 103 and the sheet-side address electrode terminal units simultaneously. Moreover, substrate-side address electrode terminal units corresponding to the sheet-side address electrode terminal units may be formed on either the first substrate 101 or the second substrate 102. The sheet-side address electrode terminal units and the substrate-side address electrode terminal units may be electrically connected to each other so that an external voltage can be applied to the address electrodes 103. Even in this case, electrode-connecting units (not shown) may be installed between the sheet-side address electrode terminal units and the substrate-side address electrode terminal units so as to ensure electrical connections between the two terminal units.

The dummy part 116 may cover not only the sheet-side scan electrode terminal units 132c but also the sheet-side address electrode terminal units. That is, the dummy unit 116 of the electrode sheet 115 can prevent the sheet-side address electrode terminal units from being damaged by external shocks or the like by covering the sheet-side address electrode terminal units.

Moreover, due to the arrangement of the address electrodes 103, it becomes possible to select discharge cells in which discharge is to occur by using the second sustain electrodes 107 and the address electrodes 103.

The electrode sheet 115 preferably further includes protective layers 109 which each cover at least a portion of the barrier structure 105. But, these protective layers 109 are not essential elements for the present embodiments. The protective layers 109 may be formed of, for example, MgO having good secondary emission characteristics, using a method, such as, deposition. Alternatively, the protective layers 109 may be formed of a material, such as carbon nanotube (CNT) having high durability.

The barrier structure 105 may be formed of glass including an element, such as Pb, B, Si, Al, or O. In some cases, the barrier structure 105 may be formed of dielectric in which fillers, such as ZrO₂, TiO₂, and/or Al₂O₃, and pigments, such as Cr, Cu, Co, Fe, and/or TiO₂, are included. If a dielectric is used to form the barrier structure 105 and a pulse voltage is applied to the sustain electrodes 106 and 107 arranged within the barrier structure 105, the dielectric induces charged particles and accumulates electric charges on the barrier structure. The accumulated electric charges participate in plasma discharge and make it possible to drive the PDP through a memory effect. The dielectric prevents the sustain electrodes 106 and 107 from being damaged due to a collision with accelerated charged particles during discharge.

The first substrate, second substrate, and electrode sheet of the PDP according to the present embodiments are not restricted to those in the present embodiment illustrated in FIGS. 2 through 6 but may have other various structures.

That is, one or two first sustain electrodes 106 for discharge and one or two second sustain electrodes 107 for discharge may be arranged in the barrier structure 105 with respect to one discharge cell. Alternatively, two, three or four sustain electrodes 106 for discharge and two, three or four second sustain electrodes 107 for discharge may be arranged in the barrier structure 105.

As illustrated in FIGS. 2 and 3, the first sustain electrodes 106 may be formed to be adjacent to each other, and the second sustain electrodes 107 may be formed to be adjacent to each other. However, the present embodiments are not restricted to this configuration. For example, the first sustain electrodes 106 and the second sustain electrodes 107 may be alternately arranged within the barrier structure 105. The first and second sustain electrodes 106 and 107 may be arranged in other various configurations, such as, the first sustain electrodes 106 and the second sustain electrodes 107 may be arranged in first barrier walls and second barrier walls, respectively, into which the barrier structure 105 is divided.

Although it is illustrated in FIG. 2 that each of the discharge cells 180 has an enclosed horizontal cross-section, the present embodiments are not restricted to this shape. For example, the horizontal cross-section of each of the discharge cells 180 may be a strip. However, when the horizontal cross-section of each of the discharge cells 180 is an enclosed shape, the sustain electrodes 106 and 107 for discharge are arranged within the barrier structure 105 while surrounding the discharge cells 180, so that cubic discharge occurs to thereby increase the amount of discharge.

As shown in FIG. 4, each of the electrodes 107, 106, and 103 may have a chain shape. More specifically, each electrode may have the shape of a chain including portions surrounding a line of discharge cells 180 and portions connecting portions that surround adjacent discharge cells 180. Of course, even when each electrode is in the shape of a ladder instead of a chain as shown in FIG. 4, it may extend long while surrounding a line of discharge cells 180. The case where each electrode has a ladder shape is also covered by the scope of the present embodiments.

In an operation of the PDP 100 illustrated in FIG. 2, address discharge is generated by applying an address voltage between the address electrodes 103 and the second sustain electrodes 107 which are common electrodes. Consequently, discharge cells 180 where sustain discharge is to occur are selected. Here, the address voltage is provided by an external power supply and applied to the address electrodes 103 via sheet-side terminal units (not shown) corresponding to the address electrodes 103 within the PDP 100.

Thereafter, a discharge sustain voltage is applied between the first sustain electrodes 106 and the second sustain electrodes 107 corresponding to the selected discharge cells 180. Sustain discharge occurs due to the movement of wall charges that accumulate on the first and second sustain electrodes 106 and 107. During the sustain discharge, the energy level of excited discharge gas decreases, and thus ultraviolet rays are radiated. Here, the discharge sustain voltage is provided by an external power source and successively applied to the substrate-side terminal units 132a, the electrode-connecting units 132b, the terminal connection portions 132c₂, the terminal base portions 132c₁, and the sustain electrodes 107 within the PDP 100.

The ultraviolet rays excite the phosphor of the phosphor layers 110a and 110b coated within the discharge cells 180. The energy level of the excited phosphor decreases, and thus visible light is emitted. The visible light penetrates the first substrate 101 and comes outside, thereby forming an image which a user can see.

Although only the substrate-side scan electrode terminal units 132a formed on the second substrate 102 are shown in the embodiment of FIGS. 2, 3, and 4, the substrate-side common electrode terminal units (not shown) are also formed on the first substrate 101, the sheet-side common electrode terminal units (not shown) are also formed on the electrode sheet 115. The substrate-side common electrode terminal units may be electrically connected to the sheet-side common electrode terminal units. Similar to the substrate-side scan electrode terminal units 132a, electrode-connecting units (not shown) each having a predetermined length are preferably arranged between the substrate-side common electrode terminal units and the sheet-side common electrode terminal units so as to achieve secure electrical connection between the two terminals.

As described above, if the locations of the scan electrodes and the common electrodes change, the locations of the terminal units may accordingly change between the first and second substrates. Even when this change is not shown and described, it will be understood by those of ordinary skill in the art that this change is covered by the scope of the present embodiments.

In a PDP according to the present embodiments, electrode-connecting units have an improved structure so that an electrode sheet and a substrate are stably electrically connected to each other.

In addition, all of the electrode-connecting units are formed on the same substrate, so that the manufacture of the electrode-connecting units is simplified, resulting in a reduction of the manufacturing costs of a PDP.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a pair of substrates spaced apart from each other and arranged substantially parallel to each other;
an electrode sheet arranged between the two substrates comprising electrodes and a barrier structure that defines discharge cells where discharge occur;
sheet-side terminal units arranged outside the electrode sheet and electrically connected to the electrodes;
substrate-side terminal units arranged outside one of the two substrates and electrically connected to the sheet-side terminal units; and
electrode-connecting units interposed between the sheet-side terminal units and the substrate-side terminal units.

2. The plasma display panel of claim 1, wherein each of the electrode-connecting units has a predetermined length and uniform thickness.

3. The plasma display panel of claim 1, wherein the electrode-connecting units are formed on the substrate-side terminal units and connected to the sheet-side terminal units.

4. The plasma display panel of claim 3, wherein each of the electrode-connecting units is thinner at the end contacting each of the sheet-side terminal units than the end contacting each of the substrate-side terminal units.

5. The plasma display panel of claim 1, wherein a discharge gas is included in the discharge cells and phosphor layers are coated on the discharge cells.

6. The plasma display panel of claim 1, wherein the electrodes formed in the electrode sheet include common electrodes and scan electrodes.

7. The plasma display panel of claim 6, wherein the common electrodes and the scan electrodes cross each other.

8. The plasma display panel of claim 6, further comprising address electrodes arranged on the electrode sheet or one or both of the two substrates and intersecting the scan electrodes.

9. The plasma display panel of claim 8, wherein the address electrodes are arranged between the common electrodes and the scan electrodes on the electrode sheet.

10. The plasma display panel of claim 8, wherein each of the address electrodes is in the shape of a chain.

11. The plasma display panel of claim 8, wherein the address electrodes are arranged to have a ladder shape which surrounds the discharge cells.

12. The plasma display panel of claim 6, wherein each of the common electrodes and/or the scan electrodes is in the shape of a chain.

13. The plasma display panel of claim 6, wherein the common electrodes and/or the scan electrodes are arranged to have a ladder shape which surrounds the discharge cells.

14. The plasma display panel of claim 6, wherein:
the sheet-side terminal units include sheet-side common electrode terminal units connected to the common electrodes and sheet-side scan electrode terminal units connected to the scan electrodes;
the substrate-side terminal units include substrate-side common electrode terminal units and substrate-side scan electrode terminal units;
the sheet-side common electrode terminal units are electrically connected to the substrate-side common electrode terminal units, and the sheet-side scan electrode terminal units are electrically connected to the substrate-side scan electrode terminal units; and
at least one electrode-connecting unit is interposed in at least one space between each common electrode terminal unit and each scan electrode terminal unit.

15. The plasma display panel of claim 1, wherein the electrode sheet further comprises protective layers covering at least a portion of each of the inner walls of the barrier structure.

16. The plasma display panel of claim 1, wherein grooves corresponding to spaces defined by the barrier structure in the electrode sheet are formed on at least one of the two substrates so that the volume of each of the discharge cells increases.

17. The plasma display panel of claim 14, wherein a phosphor layer is formed on at least a portion of each of the grooves which define the discharge cells.

18. The plasma display panel of claim 8, wherein substrate-side address electrode terminal units connected to the address electrodes are arranged on at least one of the two substrates.

19. The plasma display panel of claim 1, wherein the electrode sheet is formed using the thick film ceramic sheet (TFCS) method.

20. The plasma display panel of claim 1, wherein the electrodes comprise a non-transparent or non-translucent substance with good electrical conductivity.
